(19) United States
(12) Patent Application Publication
(10) Pub. No.: US 2018/0116262 A1
(43) Pub. Date: May 3, 2018

(54) METHOD FOR COOKING A CHICKEN WITH AN OVERCOOKED RICE CRUST

(71) Applicant: KYELIMWON F&B, Goyang-si, Gyeonggi-do (KR)

(72) Inventor: Ik Jae SHIN, Seoul (KR)

(21) Appl. No.: 15/570,182

(22) PCT Filed: May 2, 2016
(86) PCT No.: PCT/KR2016/004617

§ 371 Date: Oct. 27, 2017

(30) Foreign Application Priority Data
Apr. 30, 2015 (KR) 10-2015-0061461

(51) Int. Cl. A23L 13/50; A23L 7/196; A23L 5/10

(52) U.S. Cl. CPC A23L 13/57; A23V 2002/00; A23L 5/10; A23L 7/1965

(57) ABSTRACT

The present invention relates to a method for cooking a chicken with an overcooked rice crust. The method may include a pre-processing step of thoroughly removing the contents and the blood from a raw chicken; a chicken-seasoning step of soaking the pre-processed chicken in mixed water of clean water and a salting agent for seasoning the chicken for a certain period of time; a high-temperature cooking step of filling the inside the belly of the salted chicken with glutinous rice and Angelica gigas and roasting the chicken with oak firewood and oak-wood charcoal; and an overcooked rice crust cooking step of flatly pushing and laying the glutinous rice, boiled within the belly of the chicken, on agalmatolite with a high-heat maintenance rate, laying the chicken on the said glutinous rice, and cooking in such a manner of making a gratine of overcooked rice crust at a high temperature.

### BACKGROUND OF THE INVENTION

### Field of the Invention

The present invention relates to a method for cooking a chicken with an overcooked rice crust, and more particularly, to the method for improving the meat quality while eliminating the peculiar smell of chicken, and preventing the trans fat from being generated when fried or cooked, thereby providing a cooking method of a roast chicken that can enrich the taste of the food while helping to take an appropriate amount of carbohydrates together and enhance the energy.

### Description of the Prior Art

Poultries are one of a major and widespread uses of protein in modern human diets. Especially, chickens among these poultries have been used as ingredients for a variety of cuisines in both of the Eastern and the Western countries. For example, chicken dishes offer a variety of cooking methods such as soup, steamed one, and roast. Among them, roast chicken is relatively easy to cook and convenient to eat, especially popular for children's snacks and simple snacks.

Conventionally, roast chicken is generally fried in oil, and if one looks at the cooking process roughly, a raw chicken is first cut into several pieces, and then the flour-based clothing is overlaid of the cut chicken. Then, it is cooked by frying for about 10 minutes in the pre-heated cooking oil from about 170 to about 180° C. As described above, a typical chicken roasted recipe is to fry a piece of chickens that is coated with dough in a cooking oil of high-temperature. Then, when the food is fried in oil at a temperature of 120° C. or higher, a colorless transparent crystalline acrylamide substance is generated. The substance called acrylamide is classified as a suspected carcinogen that causes malignant gastric tumor in an animal test. It is known that the human body has similar effects. For example, it has recently been reported that acrylamide, a potentially carcinogenic substance, has been detected in fried potatoes and baked bread sold at fast food stores, and although fried food has not been scientifically proven yet, the possibility that the fried foods can have a bad influence on the human body is still being announced. Also, in the oil-fried chicken recipe, the outer portion of the chicken. is hardened but the inside of the chickens is not fully ripe because it is cooked in a high temperature. Furthermore, there is a problem that a large amount of waste cooking oil is generated, thereby increasing the concern about environmental pollution.

Accordingly, various methods have been proposed to solve the problem of the fried chicken recipe using cooking oil. For example, in general, since meats such as chicken meat have a lot of fat, and this fat is not better than that of other meat, it is recognized that a conventional cooking method of putting in cooking oil and frying is not preferable. Accordingly, in recent years, a large number of roasted chicken have been devised by burning heat of firewood or charcoal fire. These recipes are widely used because they give a unique flavor and appearance due to firewood or charcoal, remove fat, and have a smooth texture and good taste. However, such a conventional grilling method is not desirable for the operator or the guest due to the generation of smoke due to burning of falling animal oil by a fire or a charcoal fire, and meat quality exposed to smoke may cause discomfort in the texture and the like.

Conventionally proposed techniques for improving the problem of roast chicken as described above are mainly related to a roasting device for roasting a chicken, and various types and kinds of roasting device for roasting a chicken have been proposed. However, there has been almost no proposal for a recipe and a cooking method of a roast chicken which can have a superior effect while substantially solving the above-mentioned problems. Only, for example, Korean Patent Application No. 2007-003740 discloses the following method; “the method for cooking herbal medicine roasted chicken comprising a steps of (a) adding a medicinal herb containing a persimmon tree to a pot, pouring the water, heating the mixture at a temperature of 150 to 300° C. for 2 to 3 hours, and then cooling the mixture to a temperature of 15 to 20° C. to prepare a concentrated concentrate of medicinal herbs; (b) adding salt and pepper to the concentrated concentrate of herbal medicine prepared in step (a) and stirring the mixture; (c) preparing the raw chicken by removing foreign. matters after removing the hair of the chicken, and by cutting and washing it, and d) dipping the raw chicken prepared in step (c) into the concentrated concentrate of herbal medicines prepared in step (b) for 2 to 3 hours; (e) applying the edible wood vinegar solution to the surface of the raw chicken after the water is removed from the raw chicken after step (d); (F) aging the chicken in step (e) for 5 to 6 hours at 0 to 5° C.; and (g) baking the aged chicken at the step (f) at 170 to 180° C. for 40 to 50 minutes”. Korean patent early publication No. 2009-0107881 discloses “the chicken, duck roasting method comprising of cleaning steps to remove and clean chicken, or duck hair, viscera, head, and feet; soaking step of the washed chicken and the duck in the washing step in water diluted with concentrate of ginseng or red ginseng and aging the chicken or duck to agglomerate the chicken or duck so that the hemp concentrate is permeated into the flesh of the chicken or the duck; forming step of oil retention coating film for forming coating film on the surfaces of the chicken and duck by using the grains containing the retention component as a fuel and by cooking the aged chickens and ducks in the aging stage of the hemp concentrate. Korean Patent Early Publication No. 2011-0021144 discloses the following method; “the method for cooking a roasted chicken containing a herb comprising first step of preparing a raw chicken; second step of preparing a herbal sauce and adding it to the chicken; third step of putting the chicken to which the second-stage herb seasoning is added in a mixture of olive oil and white wine for 30 to 40 minutes; and fourth step of baking the chicken in the third step”.

However, the above-mentioned. conventional techniques are merely used for improving the meat quality by using various herbal medicines, specific ingredients such as ginseng or red ginseng or herbs for roasting chicken, adding the characteristics of the used food ingredients, or by preventing the main ingredients or juice from losing to the outside or to prevent the use of chemical seasoning and to improve the taste and flavor. However, there has been no proposal for a roasted chicken recipe that is a well-being food that has prevented the trans-fats from forming in advance, but also helps to enrich the taste of the food and to take an appropriate amount of carbohydrates together.

### PATENT DOCUMENT

Patent document 1: Korean Patent Application No. 2007-0033740

Patent document 2: Korean patent early publication No. 2009-0107881

Patent document 3: Korean Patent Early Publication No. 2011-0021144

### SUMMARY OF THE INVENTION

Accordingly, the present invention has been made in view of the problems occurring in the prior art, and it is the main purpose of the present invention to solve the problems in the conventional technology described above and to meet social demands for healthy eating, as well as to provide the method for improving the meat quality while eliminating the peculiar smell of chicken, and preventing the trans fat from being generated when fried or cooked, thereby providing a cooking method of a roast chicken that can enrich the taste of the food while helping to take an appropriate amount of carbohydrates together and enhance the energy.

The other object of the present invention is to provide a method of cooking a roasted chicken in accordance with the above-described characteristics in a proper combination with other carbohydrate-based foodstuffs.

The other object of the present invention is to provide a chicken roasted by the above-described method.

Still another object of the present invention is to achieve other objects which can be easily conceived by a person skilled in the art from the above-described clear objects and the description of the specification of the present invention.

The said object of the present invention could be achieved by finding out the fact that the overcooked rice crust as Arida Oryza Praeparatum may be used as a kind of medicines and that it is used for roast chicken based on providing a pleasant-tasting, which is described at the Dong-uibogam (Korean traditional medical document), and a method of harmoniously cooking them.

### Means to Solve the Task

To achieve the above objects, in one aspect, the present invention provides a method for cooking a chicken with an overcooked rice crust comprising;

a pre-processing step of thoroughly removing the contents and the blood from a raw chicken;

a chicken-seasoning step of soaking the pre-processed chicken in mixed water of clean water and a salting agent for seasoning the chicken for a certain period of time;

a high-temperature cooking step of filling the inside the belly of the salted chicken with glutinous rice and Angelica gigas and roasting the chicken with oak firewood and oak-wood charcoal; and

an overcooked rice crust cooking step of flatly pushing and laying the glutinous rice, boiled within the belly of the chicken, on agalmatolite with a high-heat maintenance rate, laying the chicken on the said glutinous rice, and cooking in such a manner of making a gratine of overcooked rice crust at a high temperature.

In a preferred embodiment of the present invention, the said chicken-seasoning step is carried by aging for 7 to 10 hours at a ratio of 6.5 to 7.5 parts by weight of clean water, 2.0 to 3.0 parts by weight of salting agent and 90 to 91 parts by weight of raw chicken.

In a preferred embodiment of the present invention, the said salting agent is a mixture of an edible salt, a coloring agent, a coloring aid, a sugar, a spice and a binder reinforcing agent.

In a preferred embodiment of the present invention, the said glutinous rice inside the belly of the salted chicken is used that is soaked with 0.1% salt water for 8 hours or more.

In a preferred embodiment of the present invention, the temperature which makes an overcooked rice crust on said agalmatolite is kept at from 150 to 200° C.

In another aspect, the present invention provides the roasted chicken with the overcooked rice crust which is cooked with a method comprising a pre-processing step of thoroughly removing the contents and the blood from a raw chicken; a chicken-seasoning step of soaking the pre-processed chicken in mixed water of clean water and a salting agent for seasoning the chicken for a certain period of time; a high-temperature cooking step of filling the inside the belly of the salted chicken with glutinous rice and Angelica gigas and roasting the chicken with oak firewood and oak-wood charcoal; and an overcooked rice crust cooking step of flatly pushing and laying the glutinous rice, boiled within the belly of the chicken, on agalmatolite with a high-heat maintenance rate, laying the chicken on the said glutinous rice, and cooking in such a manner of making a gratine of overcooked rice crust at a high temperature.

Being constituting as the above, the method for cooking the chicken with the overcooked rice crust according to the present invention removes fat via a specific cooking process completely different from conventional vegetable oil frying or electric roasting method, combines the chicken with delicate-tasting overcooked rice crust to cook the chicken with overcooked rice crust, to thereby enhance meat quality while removing a unique odor of the chicken and, simultaneously, to properly instill the fat of the chicken into the overcooked rice crust while preventing trans fats, as a food for well-being, from being generated in the cooking process, making the food taste much richer and enabling a consumer to eat a proper amount of carbohydrates to energize the consumer. Accordingly, the method of the present invention is a completely new cooking method, and thus is industrially applicable.

### BRIEF DESCRIPTION OF THE DRAWINGS

The method for cooking a chicken with an overcooked rice crust according to the present invention will now be described by way of example only, with reference to the accompanying drawings, in which:

FIG. 1 is a flowchart illustrating a process of cooking a chicken with overcooked rice crust in accordance with a preferred embodiment according to the present invention.

### DETAILED DESCRIPTION OF THE INVENTION

Hereinafter, the present invention will be described in further detail with reference to preferred embodiments. It is to be understood, however, that the scope of the present invention is not limited to these embodiments.

In this specification, the present embodiments are provided to provide a complete disclosure of the present invention and to fully disclose the scope of the invention to a person having ordinary skill in the art to which the present invention belongs, and it is only defined by the claims. Accordingly, in some embodiments, well known components, well known operations, and well-known techniques are not specifically described to avoid an undesirable interpretation of the present invention.

It is to be understood that the term used herein is for the purpose of describing particular embodiments only and is not intended to be limiting of the invention. In the present specification, the singular forms include plural forms unless otherwise specified in the specification. Also, components and acts referred to as “comprising (or including)” do not exclude the presence or addition of one or more other components and acts.

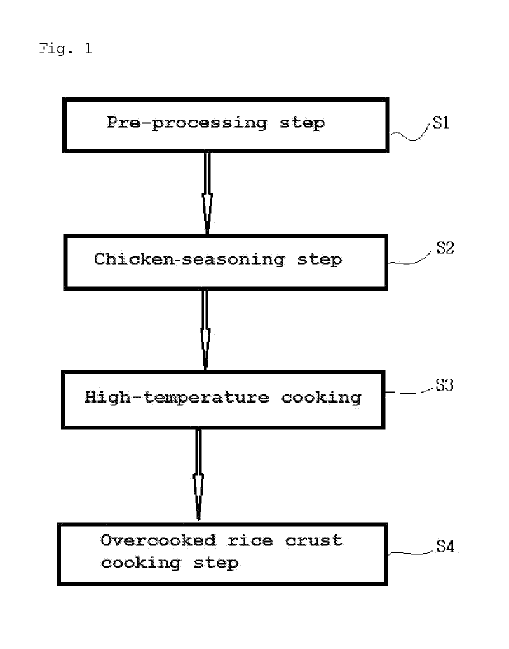

FIG. 1 is a flowchart illustrating a process of cooking a chicken with overcooked rice crust in accordance with a preferred embodiment according to the present invention.

As shown in FIG. 1, a process of cooking a chicken with overcooked rice crust according to the present invention consists of a pre-processing step (S1), a chicken-seasoning step (S2), a high-temperature cooking step (S3) using oak firewood and oak-wood charcoal, and finally an overcooked rice crust cooking step (S4) of the glutinous rice being cooked with the chicken, and thereby completing a process of cooking a chicken with overcooked rice crust through the said 4 steps. The said process according to the present invention will be described in more detail as follows.
1. Pre-processing step (S1): The pre-processing step of thoroughly removing the contents and the blood from a raw chicken is to remove the hair, the organs, the head and the feet after the slaughtering of the chicken and to wash it clean with water. It can be carried to the next step immediately after this step or it can be stored in the cold refrigerator.
2. Chicken-seasoning step (S2): The chicken-seasoning step of soaking the pre-processed chicken in mixed water of clean water and a salting agent for seasoning the chicken for a certain period of time is to infiltrate a season into the raw chicken. The said step is carried by aging for 7 to 10 hours at a ratio of 6.5 to 7.5 parts by weight, preferably 7.1 parts by weight of clean water, 2.0 to 3.0 parts by weight, preferably 2.6 parts by weight of salting agent and 90 to 91 parts by weight, preferably 91.3 parts by weight of the said pre-treated raw chicken. If the said ratio of salting agent is less than 2.0 or the aging time is shorter than 7 hours, the salting agent, which is an additive to the raw chicken, does not sufficiently infiltrate. On the contrary, if the said ratio of salting agent exceeds 3.0 parts by weight, or if the aging time is longer than 10 hours, the salty portion becomes too thick and then the chicken is unpleasant, the taste is deteriorated after cooking, which is not preferable. The said salting agent being used according to the present invention is a mixture of an edible salt, a coloring agent, a coloring aid, a sugar, a spice and a binder reinforcing agent, and refer to an additive for using to salting (curing, or preserving). Preferably, the said salting agent according to the present invention is prepared by mixing 3 parts by weight of edible salt, 5 parts by weight of red pepper powder, 2 parts by weight of ginger, 6 parts by weight of garlic, 15 parts by weight of sugar, 20 parts by weight of soy, 1 part by weight of pepper and 2 parts by weight of glutinous rice powder, and stirring the resultant mixture.
3. High-temperature cooking step (S3): At the present high-temperature cooking step, a glutinous rice that is soaked with 0.1% salt water for 8 hours or more and Angelica gigas are filled inside the belly of the said salted chicken, and the resultant chicken is roasted on oak firewood and oak-wood charcoal for 90 minutes uniformly. In this process, 200-300 g of trans fat is removed. If the ratio of the salt is more than 0.1%, the salty taste of the overcooked rice crust is strong and its texture is remarkably deteriorated. If the time to be soaked exceeds 8 hours, the texture of the overcooked rice crust is reduced and it becomes undesirable. In addition, in the present high-temperature cooking step (S3), it is considered that the essential oil, which is the main ingredient of Angelica gigas, is added with the soaked glutinous rice to the raw chicken, to effectively remove the trans fat of the raw chickens. Therefore, Angelica gigas may be added at a ratio of preferably 10 to 50 g/kg of broiler, namely the said raw chickens. If Angelica gigas is added with less than 10 g/kg of broiler, the removal efficiency of trans fat is undesirably lowered, conversely, if the amount exceeds 50 g/kg of broiler, texture of the roasted chicken are lowered and the bitterness is occurred which is not preferable.
4. Overcooked rice crust cooking step (S4): The overcooked rice crust cooking step is performed by flatly pushing and laying the glutinous rice, boiled within the belly of the chicken, on agalmatolite with a high-heat maintenance rate, for example such as agalmatolite produced at the district of Jangsu, Korea, and laying the chicken on the said glutinous rice, and cooking in such a manner of making a gratine of overcooked rice crust at from 150 to 200° C., which is high temperature but not burning. The said agalmatolite being used according to the present invention may be used with those having a height of 3 cm and a pore of 3 mm, and the diameter may be appropriately adjusted according to the size of the chicken.

The cooking process according to the present invention is not a method of adding oil, which is a fat component, in a chicken made by a conventional frying or electric grilling, but rather removing fat and, at the same time, binding the overcooked rice crust with chicken which is grilled to provide a roasted chicken of new mode.

In addition, in the the roasted chicken with the overcooked rice crust according to the present invention, the overcooked rice crust is used as a kind of first aid, and according to Dong-uibogam, it records that the overcooked rice crust can be used as a remedy for sickness that often does not swallow into the throat, or throw up even if it swallows. Therefore, the roasted chicken with the overcooked rice according to the present invention not only has superior nutritional quality having an excellent taste but also can provide a health food effect to a patient who is reluctant to eat food.

### THE BEST MODE FOR CARRYING OUT THE INVENTION

Hereinafter, the present invention will be described in detail with reference to the following examples, but the scope of the present invention is not limited to those examples.

### EXAMPLE 1

After slaughtering chickens, its hair, internal organs, head and feet were removed, cleaned with water and weighed. To infiltrate a spicy into the chickens of which the contents and the blood are removed in such way, the pre-treated chicken is aged for 8 hours at the state of a ratio of 7.1 parts by weight of clean water, 2.6 parts by weight of salting agent and 91.3 parts by weight of the said pre-treated raw chicken, wherein the said salting agent is prepared by mixing 3 parts by weight of edible salt, 5 parts by weight of red pepper powder, 2 parts by weight of ginger, 6 parts by weight of garlic, 15 parts by weight of sugar, 20 parts by weight of soy, 1 part by weight of pepper and 2 parts by weight of glutinous rice powder and stirring the resultant mixture. A glutinous rice that is soaked with 0.1% salt water for 8 hours or more and Angelica gigas are filled inside the belly of the said salted chicken with proportion of 20 g/kg of chicken, and then the resultant chicken is roasted on oak firewood and oak-wood charcoal for 90 minutes uniformly. Then, the roasted chicken with the overcooked rice crust is obtained by flatly pushing and laying the glutinous rice, boiled within the belly of the chicken, on agalmatolite produced at the district of Jangsu, Korea, with a high-heat maintenance rate, and laying the chicken on the said glutinous rice, and cooking in such a manner of making a gratine of overcooked rice crust at about 180° C., to convert the boiled glutinous rice to the overcooked rice crust.

### EXAMPLE 2

The roasted chicken with the overcooked rice crust is cooked by using the same procedure as the above Example 1 except that Angelica gigas is added with proportion of 50 g/kg of chicken.

### COMPARATIVE EXAMPLE 1

The roasted chicken with the overcooked rice crust is cooked by using the same procedure as the above Example 1 except that Angelica gigas is added with proportion of 5 g/kg of chicken.

### COMPARATIVE EXAMPLE 2

The roasted chicken with the overcooked rice crust is cooked by using the same procedure as the above Example 1 except that Angelica gigas is added with proportion of 70 g/kg of chicken.

### COMPARATIVE EXAMPLE 3

The roasted chicken with the overcooked rice crust is cooked by using the same procedure as the above Example 1 except that the salting agent is added with proportion of 1 part by weight.

### COMPARATIVE EXAMPLE 4

The roasted chicken with the overcooked rice crust is cooked by using the same procedure as the above Example 1 except that the salting agent is added with proportion of 4 parts by weight.

### EXPERIMENTAL EXAMPLE

Taste evaluation by the group for tasting the taste

The roasted chicken with the overcooked rice crust prepared according to the example 1, 2, and comparative example 1 to 4 was served to a tasting group composed of 10 adult males and 10 adult females. The taste of the roasted chicken was directly tested and the sensory evaluation was carried out. The results are shown in Table 1 below.

TABLE 1

| | | | Com. | Com. | Com. | Com. |
|---|---|---|---|---|---|---|
| Item | Ex. 1 | Ex. 2 | Ex. 1 | Ex. 2 | Ex. 3 | Ex. 4 |
| There is a | 2 | 1 | 2 | 2 | 1 | 2 |
| characteristic | | | | | | |
| smell of chicken. | | | | | | |
| Feel fatty and | 1 | 1 | 12 | 3 | 5 | 4 |
| greasy. | | | | | | |
| There is salty and | 1 | 1 | 2 | 7 | 1 | 7 |
| the texture is | | | | | | |
| deteriorated. | | | | | | |
| There is taste of | 18 | 18 | 5 | 8 | 10 | 13 |
| sesame oil and | | | | | | |
| delicious. | | | | | | |

Although the preferred embodiments of the present invention have been described for illustrative purposes, those skilled in the art will appreciate that various modifications, additions and substitutions are possible, without departing from the scope and spirit of the invention as disclosed in the accompanied claims.

What is claimed is:

1. The method for cooking a chicken with an overcooked rice crust using chicken roasted with the wood fire, the method comprising;
a pre-processing step of thoroughly removing the contents and the blood from a raw chicken;
a chicken-seasoning step of soaking the pre-processed chicken in mixed water of clean water and a salting agent for seasoning the chicken for a certain period of time;
a high-temperature cooking step of filling the inside the belly of the salted chicken with glutinous rice and Angelica gigas and roasting the chicken with oak firewood and oak-wood charcoal; and
an overcooked rice crust cooking step of flatly pushing and laying the glutinous rice, boiled within the belly of the chicken, on agalmatolite with a high-heat maintenance rate, laying the chicken on the said glutinous rice, and cooking in such a manner of making a gratine of overcooked rice crust at a high temperature;
wherein, the said chicken-seasoning step is carried by aging for 7 to 10 hours at a ratio of 6.5 to 7.5 parts by weight of clean water, 2.0 to 3.0 parts by weight of salting agent and 90 to 91 parts by weight of raw chicken, and the said salting agent is a mixture of an edible salt, a coloring agent, a coloring aid, a sugar, a spice and a binder reinforcing agent
at the said high-temperature cooking step, the said glutinous rice inside the belly of the salted chicken is used that is soaked with 0.1% salt water for 8 hours or more, and Angelica gigas is used with proportion of 10 to 50 g/kg of chicken,
at the said overcooked rice crust cooking step, the temperature which makes an overcooked rice crust on said agalmatolite is kept at from 150 to 200° C.

2. The roasted chicken with an overcooked rice crust prepared by claim 1.
